(19) United States
(12) Patent Application Publication
(10) Pub. No.: US 2019/0291224 A1
(43) Pub. Date: Sep. 26, 2019

(54) WORKPIECE ALIGNMENT SYSTEM HAVING PRESSURE SENSORS FOR ASSESSING ALIGNMENT OF A WORKPIECE WITH A FIXTURE

(71) Applicant: Ford Motor Company, Dearborn, MI (US)

(72) Inventors: Hossein Jacob Sadri, Novi, MI (US); Stephen Juszczyk, Walled Lake, MI (US); Geoffrey John Cooper, Canton, MI (US)

(73) Assignee: Ford Motor Company, Dearborn, MI (US)

(21) Appl. No.: 15/928,398

(22) Filed: Mar. 22, 2018

(51) Int. Cl. B23Q 3/18

(52) U.S. Cl. CPC B23Q 3/186; G01L 1/142

(57) ABSTRACT

The present disclosure is directed toward a workpiece alignment system that includes a fixture configured to receive a workpiece, and multiple sensors disposed at different locations along the fixture. Each of the sensors is configured to detect a force applied to the sensor and to output a signal indicative of the force applied. Based on the signal, the system determined whether a workpiece is aligned on the fixture.

### FIELD

The present invention relates to a tooling fixture that includes locators to align with a workpiece.

### BACKGROUND

The statements in this section merely provide background information related to the present disclosure and may not constitute prior art.

During the manufacturing process of an article (e.g., vehicle, furniture, electronic devices, etc), fixtures are used to accurately align a component (i.e., a workpiece) at a desired coordinate or position, and to restrict the movement of the component as it is being processed. To align the component, a fixture can include locators such as a uniaxial locator, a biaxial locator, and/or a planar locator that are configured to align the component along one or more axes.

In one implementation, the uniaxial locator and the biaxial locators are provided as pins that align with features in the component, and therefore, it is visually apparent when the component is aligned or misaligned with such locators. Alternatively, the planar locator is generally provided as two or more designated flat surfaces along the fixture that align the component along a plane, and the component is considered aligned when the component is resting on the surfaces. However, it can be difficult to assess whether the component is aligned with each of the designated surfaces. These and other issues are addressed by the teachings of the present disclosure.

### SUMMARY

This section provides a general summary of the disclosure, and is not a comprehensive disclosure of its full scope or all of its features.

In one form, the present disclosure is directed toward a workpiece alignment system that includes a fixture configured to receive a workpiece, and a plurality of sensors disposed at different locations along the fixture. Each of the sensors is configured to detect a force applied to the sensor and to output a signal indicative of the force applied.

In another form, the workpiece alignment system further includes a controller communicably coupled to the plurality of sensors and configured to determine whether the workpiece is aligned on the fixture based on the signals from the plurality of sensors.

In yet another form, the controller is a programmable logic controller.

In one form, the plurality of sensors are resistive pressure sensors, and the signals generated by the sensors are indicative of a resistance, and the controller is configured to determine that the workpiece is aligned with a given pressure sensor in response to the resistance of the pressure sensor exceeding a predetermined contact threshold.

In another form, for each of the plurality of sensor, the controller is configured to determine that the workpiece is aligned with the sensor in response to the force applied to sensor exceeding a predetermined threshold.

In yet another form, the controller is configured to determine that the workpiece is aligned on the fixture in response to the workpiece being aligned with each of the plurality of sensors.

In one form, each of the plurality of sensors is a resistive pressure sensor that includes a plurality of copper wires arranged in a grid.

In another form, each of the plurality of sensors is a resistive pressure sensor that include a two-dimensional copper film.

In yet another form, the plurality of sensors are at least one of a resistive pressure sensors, a capacitive pressure sensor, or a piezoelectric sensor.

In one form, the present disclosure is directed toward a workpiece alignment system that includes a fixture, a plurality of pressure sensors, and a controller. The fixture is configured to receive a workpiece, and has a body and a plurality of alignment blocks arranged at different locations of the body. The plurality of pressure sensors are disposed at the plurality of alignment blocks, and each of the pressure sensors is configured to detect a force applied by the workpiece and to generate a response signal indicative of the force applied. The controller is communicably coupled to the plurality of sensors to receive the response signal. For each of the plurality of sensors, the controller is configured to determine that the workpiece is aligned with the sensor in response to the force applied exceeding a predetermined threshold, and the controller is configured to determine whether the workpiece is aligned on the fixture based on a number of sensors aligned with the workpiece.

In another form, the controller is configured to determine that the workpiece is aligned on the fixture in response to the workpiece being aligned with each of the plurality of pressure sensors.

In yet another form, the workpiece alignment system includes at least three alignment blocks disposed at three different locations along the body to align the workpiece along a plane, and at least three pressure sensors to detect alignment of the workpiece with the at least three alignment blocks.

In one form, the plurality of pressure sensors are at least one of a resistive pressure sensors, a capacitive pressure sensor, or a piezoelectric sensor.

In another form, each of the pressure sensors includes a plurality of copper wires arranged in a grid and a thin film disposed on top of the plurality of copper wires.

In yet another form, each of the pressure sensors includes a two-dimensional copper film and plastic film disposed on the copper film.

In one form, the present disclosure is directed toward a workpiece alignment system that includes a fixture, multiple pressure sensors, and a controller. The fixture has a body and multiple blocks arranged at different locations of the body. The multiple pressure sensors are disposed at the multiple blocks and operable to generate a response signal indicative of a force applied to the sensor. The controller is configured to receive the response signals from the sensors and to determine whether the workpiece is aligned on the fixture based on the response signals from the sensors.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a workpiece alignment system in accordance with the teachings of the present disclosure;

FIG. 2 is perspective view of a sensor disposed at an alignment block in accordance with the teachings of the present disclosure;

FIG. 3 is a cross-sectional view of the sensor and alignment block of FIG. 2;

FIGS. 4A and 4B illustrates a grid sensory surface and a parallel sensory surface in accordance with the teachings of the present disclosure, respectively; and

FIG. 5 is a flowchart of an example workpiece alignment routine in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

To align a workpiece along a defined plane, a fixture includes a planar locator that includes multiple designated surface that are configured to align the workpiece along the defined. Due to dimensional variations between different workpieces, some workpieces may appear to be resting on the designated surfaces along the fixture, but may be slightly offset such that the workpiece is, for example, hovering over the surface or just slightly touching the surface. The present disclosure is directed toward a workpiece alignment system that utilizes sensors provided along the defined plane to assess whether the workpiece is aligned along the defined plane. Accordingly, the system provides an objective evaluation of the workpiece to assess alignment and is not dependent on subjective visual assessment.

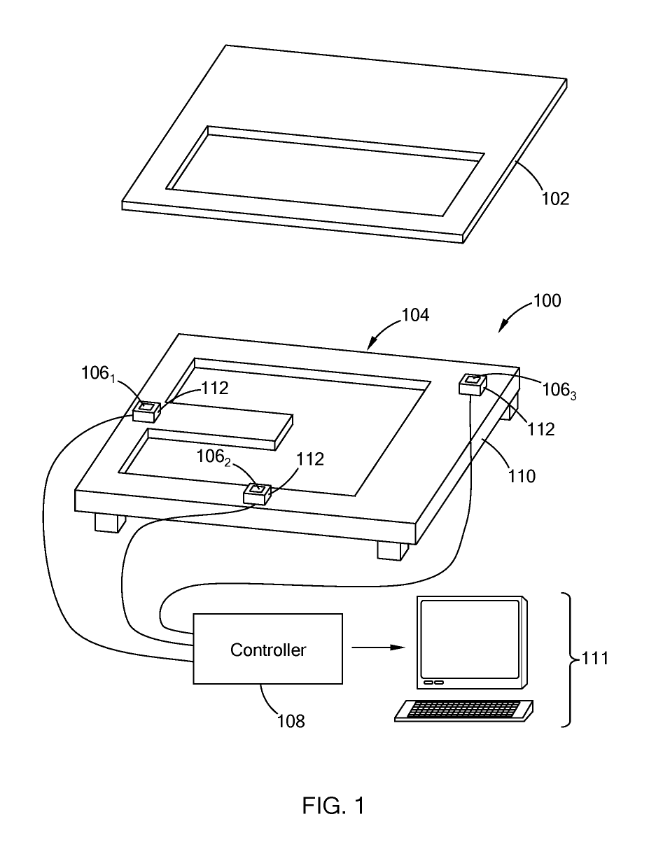

Referring to FIG. 1, a workpiece alignment system 100 is configured to receive a workpiece 102, and determine whether the workpiece 102 is aligned along a defined plane. In one form, the system 100 includes a fixture 104, a plurality of sensors 106₁, 106₂, and 106₃ (collectively sensors 106), a controller 108, and one or more user interfaces 111. While three sensors 106 are illustrated, two or more sensors 106 may be provided.

The fixture 104 aligns and secures the position of the workpiece 102 for a manufacturing procedure to be conducted. In one form, the fixture 104 includes a body 110 that is configured to support the workpiece 102, and one or more alignment blocks 112 arranged on the body 110. The alignment blocks 112 are locators that are used to align or in other words, locate the workpiece 102 on the fixture 104 along the defined plane. Accordingly, when positioned on the fixture 104, the workpiece 102 should be resting on the alignment blocks 112 and be within the defined plane.

The fixture 104 can be configured in various suitable ways based on the application, and should not be limited to the specific shape/configuration illustrated. In one variation, the fixture may include a uniaxial locator (i.e., a two-way locator) and a biaxial locator (i.e., a four-way locator) for locating and aligning the workpiece along a single axis and two axes, respectively. In another variations, the fixture 104 may include clamps that hold the position of the workpiece 102 once the workpiece is aligned with the locators.

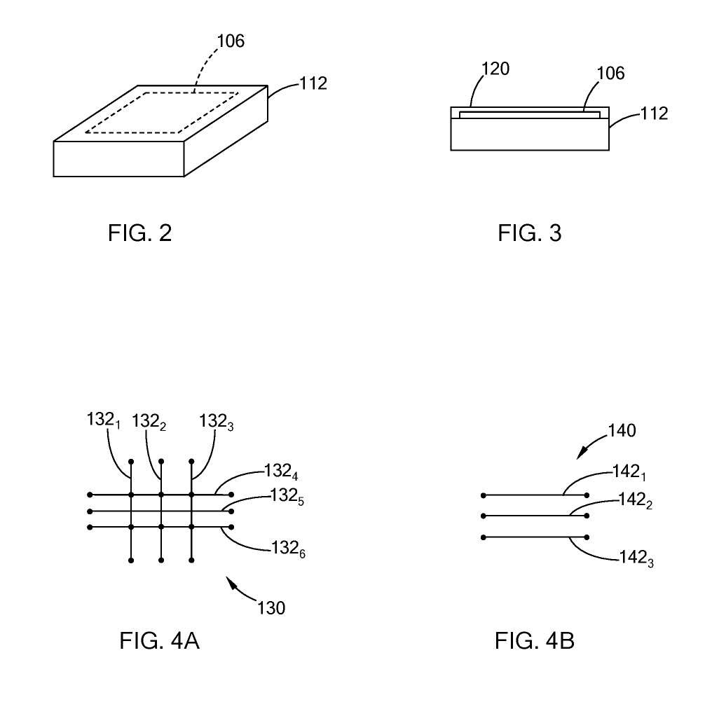

The sensors 106 are operable to detect a force, or in other words, a pressure applied to the sensor 106, and outputs a signal indicative of the force to the controller 108. In one form, each of the sensors 106 is disposed at one of the alignment blocks 112. For example, referring to FIGS. 2 and 3, the sensor 106 is provided on the surface of the alignment block 112 that is to receive the workpiece 102, and a cover 120, such as a nylon film, is disposed on top of the sensor 106 for protection. While the sensors 106 are illustrated as being at the alignment blocks 112, the sensors 106 may also be disposed directly on the body 110 at designated locations that are to contact the workpiece 102 along the defined plane.

In one form, the sensors 106 are provided as resistive pressure sensors that output a signal indicative of a resistance value. For example, in one form, each sensor 106 is coupled to a power source that applies a voltage (e.g., 1V to 5V) to the sensor 106. The sensors 106 are configured such that as pressure increases, a voltage output of the sensor 106, which is provided as the signal, increases. Based on the voltage output, the controller 108 is configured to determine the resistance and thus, the force being applied to the sensor 106. For example, using predefine algorithms and look-up tables, the controller 108 calculates the resistance and then uses the look-up table to determine the force being applied.

In another form, the contact threshold is based on a minimum contact threshold in which any contact or force applied to the sensor 106 indicates alignment. In another form, for the workpiece 102 to be considered aligned on a particular sensor 106, the force applied to the sensor 106 should be greater than a predetermined contact threshold. Specifically, the workpiece 102 may be slightly offset from the sensor 106, such that the workpiece 102 is touching the sensor 106 at, for example, a point or a contact line, but is not flat or flush on the sensor 106. Accordingly, the contact threshold is based on the amount of force the workpiece 102 places on the sensor 106 when it is substantially flush on the sensor 106, and thus, may vary based on the application.

In one form, the resistive pressure sensor has one or more resistive elements, such as copper, that forms a sensory surface to detect the workpiece 102. The resistive element may be configured in various suitable ways, such as a two dimensional film, or multiple wires stretched about a surface. For example, FIG. 4A illustrates a grid sensory surface 130 that includes six resistive element 132₁ to 132₆ and FIG. 4B illustrates a parallel sensory surface 140 that includes three resistive element 142₁ to 142₃ arranged in parallel. In both configuration, the controller 108 is configured to power each resistive element and detect the voltage output from the resistive element to determine whether the workpiece 102 is aligned on the sensor 106. The grid sensory surface 130 has multiple nodes that are defined at a region in which two resistive elements overlap, and the more nodes that undergo a force, the higher the over all force/pressure being applied. The parallel sensory surface 140 operates in a similar manner. Other resistive pressure sensors, such as strain gauges, may also be used for the sensor 106 and are within the scope of the present disclosure.

While the sensor 106 is described as a resistive pressure sensor, other suitable sensors may be implemented while remaining within the scope of the present disclosure. For example, the sensors 106 may be a capacitive pressure sensor or a piezoelectric sensor.

In one form, the controller 108 is a computer that includes a processor and memory that stores computer readable instructions that are executed by the processor. In another form, the controller 108 is provided a programmable logic controller. The controller 108 is configured communicably coupled to each of the sensors 106 to receive the signal from the sensors 106. While the controller 108 is configured to be connected via wired communication in FIG. 1, the controller 108 and the sensors 106 may exchange information via a wireless communication link such as BLUETOOTH, WI-FI, etc. In one form, when implementing wireless communication, the fixture may include a power source, such as battery, that supplies power to the sensors 106. The controller 108 is configured to communicate with an operator via the user interface 111, which includes a monitor and a keyboard. Other user interfaces may also be used, such as a mouse, external memory drive, etc.

The controller 108 is configured to determine whether the workpiece 102 is aligned on the fixture 104 based on the data from the sensors 106. In one form, the controller 108 compares the data from the sensors 106 to the contact threshold to determine if the workpiece 102 is aligned with each of the sensors. If the data exceeds the contact threshold, the workpiece 102 is determined to be aligned with the sensor 106. More particularly, based on the selected sensor and contact threshold, the controller 108 can be configure in various suitable way to determine whether the workpiece 102 is aligned with each of the sensors 106. For example, in one form, the contact threshold is a resistance value and the controller 108 is configured to calculate a resistance based on the signal from a given sensor 106. Accordingly, the workpiece 102 is considered to be aligned with the given sensor 106 when the calculated resistance of the given sensor 106 is less than then contact threshold. In another example, the contact threshold is the amount of pressure/force being applied and the controller 108 is configured to calculate the amount of pressure/force being applied based on the signal from a given sensor 106 and predetermined information that associates a characteristics of the signal (e.g., voltage, current, resistance, capacitance) with a given force value. Accordingly, the workpiece 102 is aligned with the given sensor 106 when the pressure/force being applied is greater than the contact threshold. In yet another example, the contact threshold is a voltage level and the controller 108 is configured to determine the voltage amount based on the signal. Accordingly, the workpiece 102 is aligned with the given sensor 106 when the voltage from the given sensor 106 is greater than the contact threshold.

In one form, the controller 108 is configured to determine that the workpiece 102 is aligned on the fixture when the workpiece 102 is aligned with each of the sensors 106. More particularly, if the workpiece 102 is misaligned with at least one of the sensors 106, then the controller 108 determines that the workpiece 102 is not aligned on the fixture 104. The controller 108 is configured to output the determination via the user interface, such as displaying a message on the monitor or even turning on a light indicator to indicate that the fixture is aligned (e.g., green light) or not aligned (e.g., red light). In addition, if the workpiece 102 is misaligned, the controller 108 is configured to indicate which of the sensors 106 the workpiece 102 is not aligned with. In another form, the controller 108 is configured to determine that the workpiece 102 is aligned to the fixture 104 when the workpiece 102 aligned to some of the sensors 106 and not necessarily. For example, if the fixture includes four or more sensors, the workpiece 102 can be considered aligned to the fixture when it is aligned at three of the sensors and not all four.

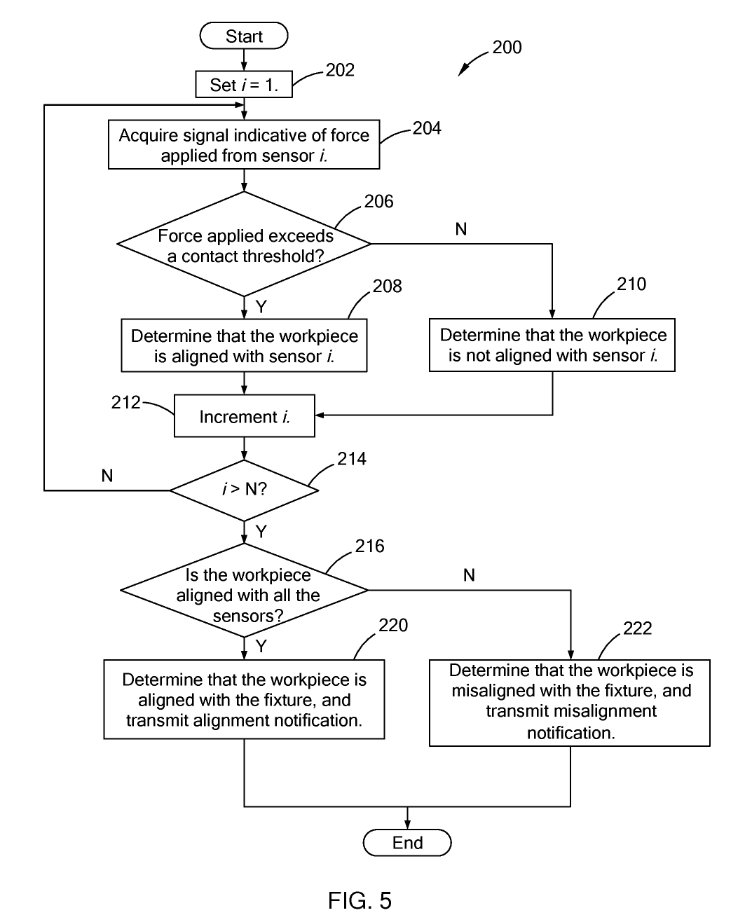

Referring to FIG. 5, an example workpiece alignment routine 200 executed by the controller 108 is provided. The controller 108 is configured to execute the routine 200 after a workpiece is positioned on the fixture. At 202, the controller 108 initializes a sensor counter to 1 (e.g., i=1), and at 204, acquires the signal from sensor i, where the signal is indicative of the force being applied to the sensor i. At 206, the controller 108 determines whether the force being applied exceeds a contact threshold. Here, the controller 108 is configured to determine the force based on the signal and then compare the calculated force with the contact threshold. In another form, the controller 108 may be configured to compare the voltage amplitude of signal to a contact threshold that is a voltage value. Accordingly, the analysis at 206 is not limited to force/pressure and may be other suitable parameters.

If the force exceeds the contact threshold, the controller 108 determines that the workpiece is aligned with sensor i, at 208, and proceeds to 212. If the force does not exceed the contact threshold, the controller 108, at 210, determines that the workpiece is not aligned the sensor i, and proceeds to 212. At 212, the controller 108 increments the counter (i.e., i+1=i), and at 214 determines if the counter is greater than the total number of sensors (i.e., N). Here, the controller 108 determines if all of the sensors has been evaluated. If no, the controller 108 continues to 204 to evaluate the signal from sensor i.

If all of the sensors have been evaluated, the controller 108, at 216, determines whether the workpiece is aligned with all of the sensors. If yes, the controller, at 220, determines that the workpiece is aligned with the fixture and transmits an alignment notification to the user interface. The alignment notification may be a message displayed on a monitor that provides the fixture is aligned, a light that is illuminated to indicate alignment, and/or other suitable notification methods. If one or more sensors are not aligned with the workpiece, the controller 108, at 222, determines that the workpiece is misaligned with the fixture, and transmits a misalignment notification to the user interface, and the routine 200 ends. The misalignment notification may be a message displayed on the monitor that indicates that the workpiece is not aligned and which sensor(s) the workpiece is misaligned with. The notification may also include a light indicator that is illuminated or other suitable notification. The routine 200 is just one example of assessing whether a fixture is aligned on the workpiece based on the signal from the sensors. Other suitable routines may also be implemented.

The workpiece alignment system of the present disclosure is configured to determine whether a workpiece is aligned along a defined plane by way of pressure sensors arranged at designated locations about the fixture. Accordingly, the alignment of the workpiece assessed using an automated system, and not based on a subjective visual assessment.

In one form, the workpiece alignment system of the present disclosure may be part of an article assembly data management system that is able to correlate the data from the workpiece alignment system with other data associated with the final article assembled using the workpiece. For example, in one application, the workpiece is processed to form an article that is installed in a vehicle, and the workpiece alignment system of the present disclosure is part of a vehicle assembly data management (VADM) system that stores and manages data regarding the manufacturing of a vehicular components/subsystems and the assembly of the vehicle. Such a VADM system is described in Applicant's co-pending application, U.S. Ser. No. 15/894,985, filed and titled “METHOD AND SYSTEM FOR LINKING FIXTURE ALIGNMENT MODIFICATIONS WITH A WORKPIECE” which is commonly owned with the present application and the contents of which are incorporated herein by reference in its entirety. The VADM system includes a dimensional automated linkage system that tracks variations in a workpiece based on adjustments made to certain locators on a fixture. When incorporated with the dimensional automated linkage system, the workpiece alignment system tracks the alignment of the part with respect to the planar locator (i.e., sensors). This information is stored and utilized by the VADM system to track dimensional/structural variations between workpieces and to analyze the information in accordance with one or more product development tools. By implementing the workpiece alignment system with the VADM system, a user, such as a product development engineer, a manufacturing operator, or a research development professional, is able to correlate alignment/misalignment between a fixture and a mounted workpiece with the final component to assist in further development and quality control of the component/part.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A workpiece alignment system comprising:
a fixture configured to receive a workpiece; and
a plurality of sensors disposed at different locations along the fixture, wherein each of the sensors is configured to detect a force applied to the sensor and to output a signal indicative of the force applied.

2. The workpiece alignment system of claim 1 further comprising a controller communicably coupled to the plurality of sensors and configured to determine whether the workpiece is aligned on the fixture based on the signals from the plurality of sensors.

3. The workpiece alignment system of claim 2, wherein the controller is a programmable logic controller.

4. The workpiece alignment system of claim 2 wherein:
the plurality of sensors are resistive pressure sensors, and the signal generated by the sensors are indicative of a resistance, and
the controller is configured to determine that the workpiece is aligned with a given pressure sensor in response to the resistance of the pressure sensor exceeding a predetermined contact threshold.

5. The workpiece alignment system of claim 2, wherein for each of the plurality of sensor, the controller is configured to determine that the workpiece is aligned with the sensor in response to the force being applied to the sensor exceeding a predetermined threshold.

6. The workpiece alignment system of claim 5, wherein the controller is configured to determine that the workpiece is aligned on the fixture in response to the workpiece being aligned with each of the plurality of sensors.

7. The workpiece alignment system of claim 1, wherein each of the plurality of sensors is a resistive pressure sensor that includes a plurality of copper wires arranged in a grid.

8. The workpiece alignment system of claim 1, wherein each of the plurality of sensors is a resistive pressure sensor that includes a two-dimensional copper film.

9. The workpiece alignment system of claim 1, wherein the plurality of sensors are at least one of a resistive pressure sensors, a capacitive pressure sensor, or a piezoelectric sensor.

10. A workpiece alignment system comprising:
a fixture configured to receive a workpiece and having a body and a plurality of alignment blocks arranged at different locations of the body;
a plurality of pressure sensors disposed at the plurality of alignment blocks, wherein each of the pressure sensors is configured to detect a force applied by the workpiece and to generate a response signal indicative of the force applied; and
a controller communicably coupled to the plurality of sensors to receive the response signal, wherein for each of the plurality of sensors, the controller is configured to determine that the workpiece is aligned with the sensor in response to the force applied exceeding a predetermined threshold, and the controller is configured to determine whether the workpiece is aligned on the fixture based on a number of sensors aligned with the workpiece.

11. The workpiece alignment system of claim 10, wherein the controller is configured to determine that the workpiece is aligned on the fixture in response to the workpiece being aligned with each of the plurality of pressure sensors.

12. The workpiece alignment system of claim 10, wherein the controller is a programmable logic controller.

13. The workpiece alignment system of claim 10 comprising:
at least three alignment blocks disposed at three different locations along the body to align the workpiece along a plane; and
at least three pressure sensors to detect alignment of the workpiece with the at least three alignment blocks.

14. The workpiece alignment system of claim 10, wherein the plurality of pressure sensors are at least one of a resistive pressure sensors, a capacitive pressure sensor, or a piezoelectric sensor.

15. The workpiece alignment system of claim 10, wherein each of the pressure sensors includes a plurality of copper wires arranged in a grid and a thin film disposed on top of the plurality of copper wires.

16. The workpiece alignment system of claim 10, wherein each of the pressure sensors includes a two-dimensional copper film and a plastic film disposed on the copper film.

17. A workpiece alignment system comprising:
a fixture having a body and multiple blocks arranged at different locations of the body;
multiple pressure sensors disposed at the multiple blocks and operable to generate a response signal indicative of a force applied to the sensor; and
a controller configured to receive the response signals from the sensors and to determine whether the workpiece is aligned on the fixture based on the response signals from the sensors.

18. The workpiece alignment system of claim 17, wherein the plurality of pressure sensors are at least one of a resistive pressure sensors, a capacitive pressure sensor, or a piezoelectric sensor.

19. The workpiece alignment system of claim 17, wherein for each pressure sensor, the controller is configured to determine that the workpiece is aligned with the pressure sensor in response to the force being applied exceeding a predetermined threshold.

20. The workpiece alignment system of claim 19, wherein the controller is configured to determine that the workpiece is aligned on the fixture in response to the workpiece being aligned with each of the plurality of sensors.
